(19) United States
(12) Patent Application Publication
(10) Pub. No.: US 2006/0097550 A1
(43) Pub. Date: May 11, 2006

(54) Self-adjust able anti-chucking device

(76) Inventors: John Wang, Ann Arbor, MI (US); David Rogers, Southfield, MI (US)

Correspondence Address: ANNA SHIH;CARLSON, GASKEY & OLDS, P.C., 400 WEST MAPLE ROAD, SUITE 350, BIRMINGHAM, MI, 48009, US

(21) Appl. No.: 10/983,267

(22) Filed: Nov. 8, 2004

(51) Int. Cl. B60J 5/00

(52) U.S. Cl. 296/207

(57) ABSTRACT

A self-adjustable anti-chucking device for a vehicle liftgate includes a wedge portion that is attachable to the liftgate and a base portion that is attachable to a vehicle body. The wedge portion includes a wedge-shaped slider block that is biased by a resilient member. The base portion includes an oblique surface shaped to contact a surface of the slider block. When the liftgate is closed and latched, the friction between the slider block and the oblique surface and the biasing force of the resilient member securely hold the liftgate in place. If the liftgate shifts position, the biasing force of the resilient member will cause the slider block to shift to compensate for any change in the liftgate position relative to the vehicle body.

### TECHNICAL FIELD

The present invention relates to vehicle liftgate components, and more particularly to a device for preventing chucking of the liftgate.

### BACKGROUND OF THE INVENTION

Sport utility vehicles, trucks, and other larger vehicles often have a liftgate to provide user access to the rear of the vehicle. The liftgate is held closed by a latch disposed on a bottom edge of the liftgate. However, the latch alone is not enough to hold the liftgate in place due to the forces encountered by the liftgate, particularly while the vehicle is driven over rough surfaces. Although the latch secures the liftgate on its bottom edge and hinges secure the liftgate on its top edge, this still leaves the side edges of the liftgate free to move relative to the vehicle. The large size and weight of the liftgate will therefore cause the liftgate to twist, creating high stress points on the latch and causing the liftgate to rattle, or “chuck,” against the side of the vehicle, particularly against the D-pillars.

To reduce the amount of stress on the latch and prevent chucking, anti-chucking devices may be attached to the liftgate and the D-pillar. One such device includes a male pin disposed on a side edge of the liftgate and a female base on the D-pillar. When the liftgate is closed and latched, the male pin fits into the female base to prevent movement of the liftgate in the Y-direction relative to the vehicle. The anti-chucking device still allows the liftgate to move in the Z-direction to accommodate play in the latch and the hinge without rattling.

Over time, however, repeated Z-direction forces on the male pin within the female base will create stress on the pin itself, potentially expanding the sides of the opening in the base and allow chucking and rattling. If the stress on the pin is great enough, the pin itself may break off, causing the chucking to be great enough to potentially cause vehicle damage.

There is a desire for a liftgate anti-chucking device that does not experience the problems encountered by prior art devices.

### SUMMARY OF THE INVENTION

The invention is generally directed to a self-adjustable anti-chucking device for a vehicle liftgate. The device includes a wedge portion that is attachable to one of the liftgate and the vehicle body and a base portion that is attachable to the other of the liftgate and the vehicle body. The wedge portion includes a wedge-shaped slider block that is biased by a resilient member and movable along a channel. The base portion includes an oblique surface shaped to contact a surface of the slider block.

When the liftgate is closed and latched, the slider block in the wedge portion contacts the oblique surface of the base portion and pushes the slider block against the biasing force of the resilient member. The friction between the slider block and the oblique surface securely holds the liftgate and prevents the liftgate from excessive movement in the Y-direction while still allowing the liftgate to move slightly in the Z-direction. Moreover, if the liftgate shifts position slightly due to, for example, twisting, the biasing force of the resilient member will cause the slider block to shift to compensate for any change in the liftgate position relative to the vehicle body.

The inventive self-adjusting wedge configuration prevents the liftgate from impacting the vehicle body without creating stress in the anti-chucking device itself. Instead, the resilient member absorbs any forces caused by movement of the liftgate, repositioning the slider block so that it remains firmly engaged against the oblique surface even if the gap between the edge of the liftgate and the vehicle body changes size as the vehicle moves.

### BRIEF DESCRIPTION OF THE DRAWINGS

FIG. 1 is a perspective view of an anti-chucking device according to one embodiment of the invention;

FIG. 2 is a representative diagram of a vehicle having the inventive anti-chucking device;

FIG. 3 is a plan view of a base portion of the device shown in FIG. 1;

FIG. 4 is an exploded view of a wedge portion of the device shown in FIG. 1;

FIG. 5 is an example of a plan view of the device when a liftgate is in an open position;

FIG. 6 is an example of a plan view of the device when a liftgate is in a closed position;

FIG. 7 is an example of a plan view of the device when the liftgate is encountering a force.

### DETAILED DESCRIPTION OF THE PREFERRED EMBODIMENT

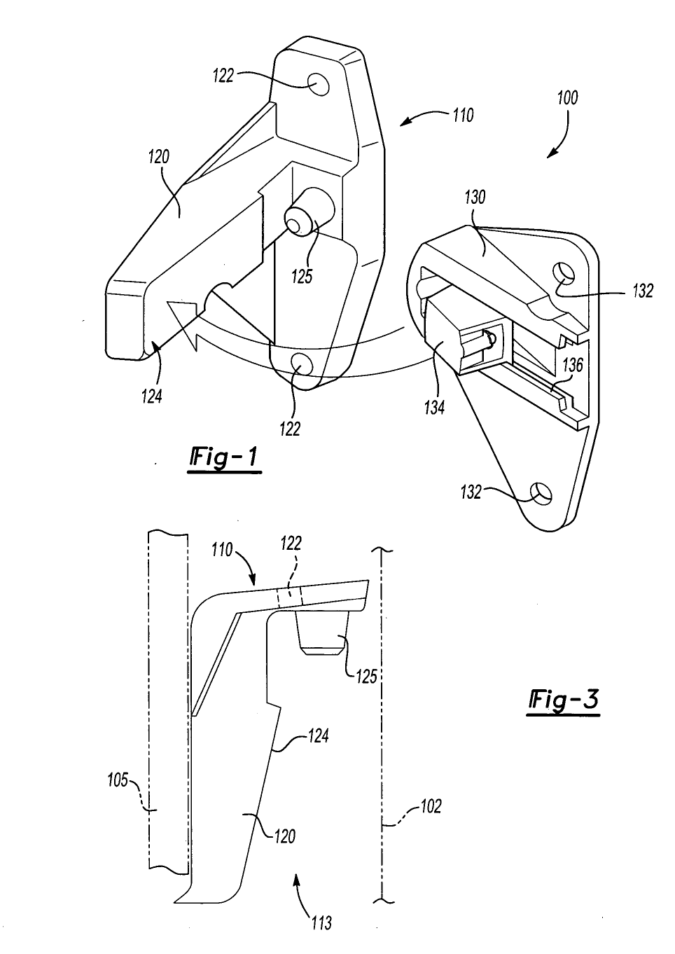

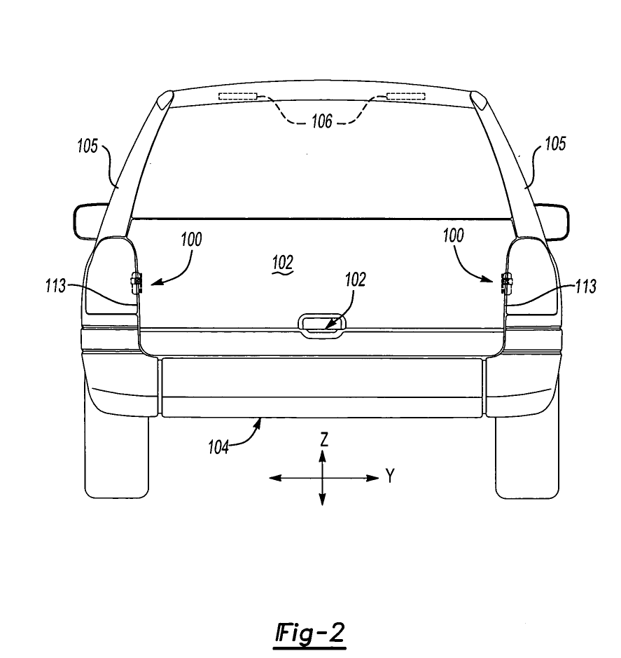

Referring to FIGS. 1 and 2, a self-adjustable anti-chucking device 100 is designed to fit between a side edge of a liftgate 102 and a portion of a vehicle body 104, such as a D-pillar 105. As shown in FIG. 2, the liftgate 102 is secured to the vehicle at its top edge by a hinge mechanism 106 and is held in place by a latch 108 when the liftgate 102 is closed. The anti-chucking device 100 prevents excessive movement of the liftgate 102 relative to the vehicle body 104 in the Y-direction while still allowing the liftgate 102 to move in the Z-direction to accommodate any play in the hinge 106 and/or latch 108.

In the examples shown in the Figures and discussed below, only a left-handed device 100 for the left side of the vehicle is shown for clarity. Those of skill in the art will understand that the right-handed device 100 for the right side of the vehicle will be a mirror image of the left-handed structure illustrated and described below.

The anti-chucking device 100 comprises a base portion 110 and a wedge portion 112. In this example, the base portion 110 is designed to attach to the vehicle body 104 at the D-pillar 105 and the wedge portion 112 is designed to attach to the liftgate 102. Note that the base portion 110 may be attachable to the liftgate 102 and the wedge portion 112 may be attachable to the vehicle body 104 without departing from the scope of the invention. When the liftgate 102 is closed, the wedge portion 112 is forced against the base portion 110 so that the anti-chucking device 100 securely fills any gap 113 between the liftgate 102 and the D-pillar 105. Both the base portion 110 and the wedge portion 112 may be made from any suitable material, such as plastic.

FIG. 3 shows the base portion 110 in more detail. In this example, the base portion 110 includes a platform 120 with one or more openings 122 that can accommodate a fastener, such as a bolt or rivet (not shown), to attach the base portion 110 to the D-pillar 105. The base portion 110 also includes an oblique surface 124 designed to engage with the wedge portion 112. A resilient bumper 125 may be attached to the base portion 110 and arranged so that the oblique surface 124 slants toward the bumper 125. The bumper 125 dampens any potential impact between the wedge portion 112 and the base portion 110.

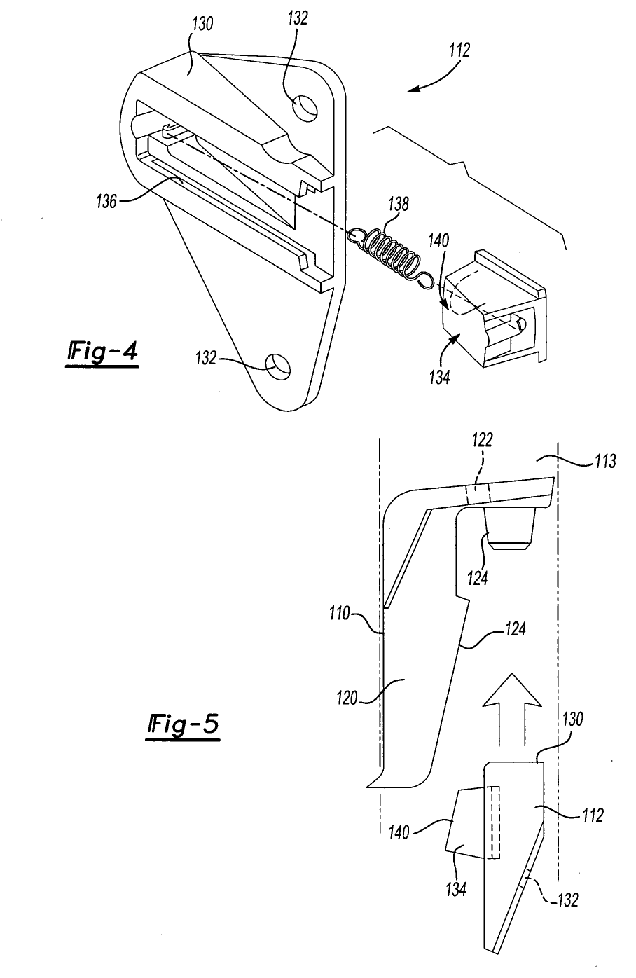

FIG. 4 illustrates the components of the wedge portion 112 of the anti-chucking device 100 in greater detail. The wedge portion 112 includes a wedge platform 130 with one or more openings 132 for accommodating a fastener, such as a bolt or rivet (not shown) to attach the wedge portion 112 to the liftgate 102. A slider block 134 is disposed in a channel 136 and is resiliently biased by a resilient member 138, such as a spring. The slider block 134 has a frictional surface 140 designed to engage with the oblique surface 124 on the base portion 110 when the liftgate 102 is closed. Depending on the amount of force applied to the slider block 134, the slider block 134 can move within the channel 136 against or with the biasing force of the resilient member 138. The frictional surface 140 and/or the oblique surface 124 may be textured, if desired, to increase the frictional engagement between the frictional surface 140 and the oblique surface 124.

Referring to FIGS. 5 through 7, the position of the slider block 134 relative to the rest of the wedge portion 112 and the oblique surface 124 depends on the position of the liftgate 102 relative to the D-pillar 105. In the example shown in FIG. 5, when the liftgate 102 is open, the biasing force of the resilient member 138 pulls the slider block 134 to a retracted position. As can be seen in FIG. 5, there is no contact between the frictional surface 140 of the slider block 134 and the oblique surface 124 of the base portion 110 at this time. Thus, there is no force opposing the biasing force of the resilient member 138 to move the slider block 134 when the liftgate 102 is open.

When the liftgate 102 is closed, both the base portion 110 and the wedge portion 112 are disposed in the gap 113 formed between the liftgate 102 and the D-pillar 105. At this point, the frictional surface 140 of the slider block 134 engages with the oblique surface 124 of the base portion 110, causing the slider block 134 to move within the channel 136 against the biasing force of the resilient member 138. The resilient member 138 causes the slider block 134 to slide to a position that ensures a tight fit of the slider block 134 against the oblique surface 124, thereby filling in the gap 113 completely. This tight engagement between the frictional surface 140 and the oblique surface 124 prevents the liftgate 102 from chucking or otherwise moving relative to the D-pillar 105 in the Y-direction.

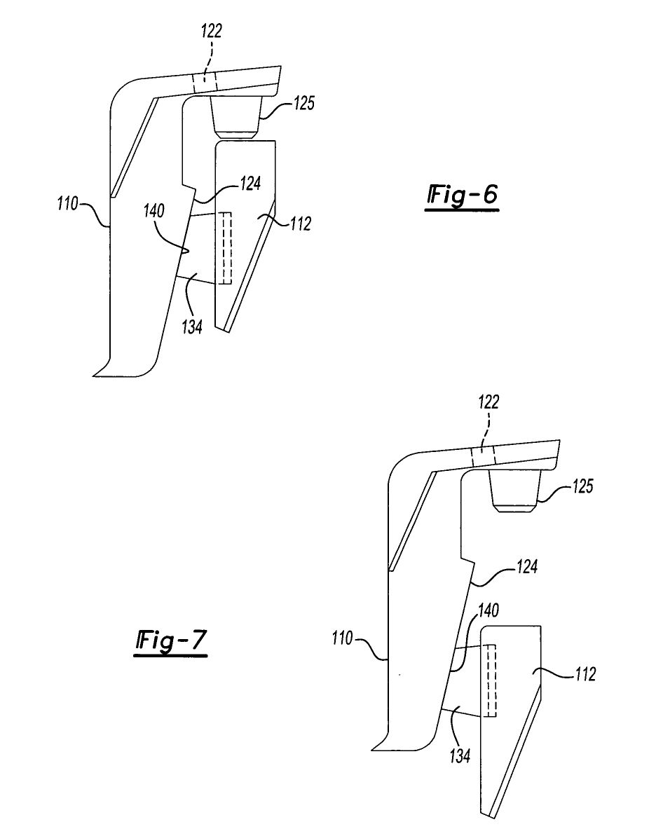

FIG. 7 illustrates an example where the relative position of the liftgate 102 and the D-pillar 105 shift from the position of FIG. 6, changing the size of the gap 113. As is known in the art, the relative positions of the liftgate 102 and the D-pillar 105 can change as the vehicle moves due to, for example, driving over rough surfaces and/or through twisting forces. As the size of the gap changes 113, the relative forces applied to the slider block 134 by the liftgate 102 and the resilient member 138 may cause the position of the slider block 134 to change. As a result, the position of the slider block 134 may shift within the channel 136 to accommodate any changes in the size of the gap 113. This shifting ensures that the anti-chucking device 100 will always fill the entire gap 113 via the position of the wedge-shaped slider block 134. More particularly, the position of the slider block 134 will adapt to the size of the gap 113 as it moves against and with the biasing of the resilient member 138.

The self-adjustable structure of the inventive anti-chucking device therefore prevents chucking by dynamically adapting its configuration to fill the gap between the liftgate and the vehicle body even if the size of the gap changes. The resilient biasing of the sliding block and the slanted, wedge-shaped surface of the sliding block and the base portion ensures that the base portion and the wedge portion maintain intimate contact, regardless of the size of the gap, and prevent chucking while still allowing desirable movement of the liftgate (e.g., in the Z-direction) without damage to any of the device components.

It should be understood that various alternatives to the embodiments of the invention described herein may be employed in practicing the invention. It is intended that the following claims define the scope of the invention and that the method and apparatus within the scope of these claims and their equivalents be covered thereby.

What is claimed is:

1. An anti-chucking device for a vehicle liftgate, comprising:
a base portion having a first surface;
a sliding block having a second surface; and
a resilient member having a biasing force that biases the sliding block, wherein the first surface and the second surface contact each other when the vehicle liftgate is in a closed position to push the sliding block against the biasing force of the resilient member.

2. The device of claim 1, further comprising a wedge platform that supports the sliding block.

3. The device of claim 2, wherein the wedge platform includes a channel in which the sliding block moves, and wherein the resilient member is disposed in the channel.

4. The device of claim 1, wherein the first surface is an oblique surface and the second surface is a slanted frictional surface.

5. The device of claim 4, wherein at least one of the oblique surface and the frictional surface is textured.

6. The device of claim 1, further comprising a bumper disposed on the base portion.

7. The device of claim 1, wherein the resilient member is a spring.

8. A vehicle structure comprising:
a liftgate movable between an open position and a closed position;
a vehicle body having at least one pillar; and
at least one anti-chucking device oriented on at least one side of the liftgate, said at least one anti-chucking device comprising
a base portion disposed on said at least one pillar and having an oblique surface,
a wedge portion attached on at least one side of the liftgate, the wedge portion having
a wedge platform,
a sliding block supporting the sliding block, wherein the sliding block has a slanted frictional surface, and
a resilient member having a biasing force that biases the sliding block, wherein the oblique surface and the frictional surface contact each other when the liftgate is in the closed position to push the sliding block against the biasing force of the resilient member.

9. The structure of claim 8, wherein said at least one anti-chucking device comprises a first anti-chucking device oriented on a first side of the liftgate and a second anti-chucking device oriented on a second side of the liftgate.

10. The structure of claim 8, wherein the wedge platform includes a channel in which the sliding block moves, and wherein the resilient member is disposed in the channel.

11. The structure of claim 8, wherein at least one of the frictional surface and the oblique surface is textured

12. The structure of claim 8, further comprising a bumper disposed on the base portion to absorb contact force from the wedge portion.
